(19) United States
(12) Patent Application Publication
(10) Pub. No.: US 2002/0170766 A1
(43) Pub. Date: Nov. 21, 2002

(54) Vehicle frame cross-member construction

(76) Inventors: Paul F. Gantz, Brookfield, WI (US); William A. Crusan, Waukesha, WI (US); Mark E. Milligan, Waukesha, WI (US); Thomas A. Smith, Menomonee Falls, WI (US); Richard H. Roggenbauer, Hartford, WI (US); Gary J. Zolp, Adell, WI (US); James A. Semmelhack, Wind Lake, WI (US)

Correspondence Address: TIMOTHY A FLORY, VAN DYKE GARDNER LINN & BURKHART LLP, P O BOX 888695, GRAND RAPIDS, MI, 49588-8695, US

(21) Appl. No.: 09/862,190

(22) Filed: May 21, 2001

(51) Int. Cl. B62D 21/00

(52) U.S. Cl. 180/311; 280/781

(57) ABSTRACT

A frame and cradle assembly for a vehicle comprising side rails and at least one cross member extending there between that define a ladder-like frame having a forward and rearward portion that correspond to the front and rear of a vehicle. At least one mechanical stop disposed on the cross members properly positions the cross members for attachment to the side rails via a tube through tube joint, resulting in a rigid assembly.

### FIELD OF THE INVENTION

The present invention relates generally to frame and cradle assemblies for vehicles. The present invention particularly relates to an improved structure for a side rail and cross member structure for use with a vehicular body and frame assembly.

### BACKGROUND OF THE INVENTION

All vehicles require some type of structural support assembly which is supported upon a plurality of ground engaging wheels by a resilient suspension system. The most common structural support systems are divided into two general categories, namely, separate body-on-frame and unibody. The separate body-on-frame and unibody assemblies are alternative construction methods applied in the automotive industry.

In the separate body-on-frame assembly, the structural components of the body portion and the frame portion are separate and independent from one another. The frame portion is resiliently supported upon the vehicle wheels by the suspension system and serves as a platform upon which the body portion and other components of the vehicle can be mounted. Similarly, separate automotive cradles may be used to mount certain components to a unibody frame. One example of such a cradle is an engine cradle which supports the engine when attached to a unibody frame. The structure of the body consists of a number of formed members joined together at nodes made from a variety of aluminum or steel product forms. Separate body and frame assemblies of this general type are often found in trucks, sport utility vehicles, and automotive cradles.

In a typical vehicle frame, cross members extend transversely relative to two parallel side rails, and are permanently secured to the side rails to form a generally rectangular vehicle frame assembly. The cross members are usually secured to the side rails by welding, bolts or rivets. Once the vehicle frame assembly is completed, the remaining components of the vehicle, including the body, drive train, and suspension, can be mounted thereon in a known manner. The side rails are manufactured to a predetermined length which is appropriate for the particular vehicle. The side rails may be formed as single or multiple members that extend most or all of the length of the vehicle. Typically, the side rails are formed from two or more pieces that are overlapped and then bolted, welded, riveted, or otherwise secured together to form a box-shape, i.e., enclosed or tubular, at selected locations along the side rail. Once the side rails are made to length, the frame is assembled by joining the appropriate number of cross members to the side rail to form a single structure. This assembly process has experienced favorable results and wide acceptance, but there is need for improvement.

A stiffer frame is desired in order to enhance the ride and vibration characteristics of the vehicle. The most acceptable way to increase stiffness of the structure is to use more “boxed” cross members and side rails. The increase in boxing of these components can make it more difficult to attach the cross members and side rails together quickly and rigidly without using more expensive subassemblies or tooling. The reason is that instead of simply matching two or three sides of a boxed section together for attachment purposes, all sides must contact each other. The more contact between parts, the more precise they must match. Moreover, the more precise the part the more expensive the part. A better fit typically provides the benefit of a better and more durable joint.

The requirements of boxed sections coming together also can impact the assembly process in another way—“fit up” problems. The boxing of the structures makes them stiffer and less forgiving when the structures are joined. Special care must be exercised to get the required structure fit up. This can result in a slower assembly process, which can add significantly to the cost of the frame, or cradle. Or, the required special care will add to the cost of tooling to form a more precise fit up surface.

In view of the above, it is apparent that there is a need to provide a more rigid and durable vehicle frame assembly. A more rigid frame improves the steering and handling of the vehicle. There is also a need to provide a vehicle frame that is efficient and simple to assemble. An efficient assembly process reduces the overall procedure time required and therefore reduces labor costs and other overhead.

The present invention is drawn to solve the problems associated with assembly of the multi-component vehicle frames.

### BRIEF SUMMARY OF THE INVENTION

In view of the foregoing, it is an object of the present invention to provide a vehicle frame or cradle assembly that addresses the limitations and disadvantages associated with prior vehicle frames, yet meets the needs of the users.

A further object of the invention is to provide a reliable vehicle frame assembly that, requires minimal effort by the user to assemble.

Still another object of the invention is to provide a vehicle frame assembly that reduces vehicle frame manufacturing times and associated costs.

In one embodiment of the invention, two elongated longitudinal members or side rails are positioned to form the side rails of the vehicle frame or cradle. At least one tubular cross member is connected to the side rails. A collar or stop member is formed proximate each end of the at least one cross member for attachment to side rails. Each side rail has at least one opening extending transversely through the side walls. The number of openings in the side rails correspond to the number of cross members. Each end of cross member is placed through an opening in a side rail, extending completely through the side rail and beyond the distal side wall of the side rail. The at least one cross member is rigidly attached to the side rails.

These and other objects not specifically enumerated herein are believed to be addressed by the present invention which contemplates a vehicle frame assembly that includes a left and right longitudinal members or side rails, at least one cross member rigidly attached to the side rails via a tube through tube joint to form a stiff vehicle frame.

### BRIEF DESCRIPTION OF THE DRAWINGS

For the purpose of illustrating the invention, there is shown in the drawings a form which is presently preferred; it being understood, however, that this invention is not limited to the precise arrangements and instrumentalities shown.

FIG. 1 is a perspective view of a preferred embodiment of the present invention including a plurality of cross members engaging the side rails to form a vehicle frame assembly.

FIG. 2 is a cross sectional view of a side rail of the present invention taken at 4-4 of FIG. 1.

FIG. 3 is a side perspective view of a cross member of the present invention.

FIG. 4 is a detailed end view of the present invention.

FIG. 5 is a detailed view of FIG. 4 taken at 5-5.

### DETAILED DESCRIPTION OF THE INVENTION

The description contained herein relates to the specific structures of a vehicle frame assembly, as presently contemplated. This description, however, is intended to be illustrative only and not limiting as to the scope of the present invention. For example, while the invention will be described in the context of light truck frame, the invention is applicable to a variety vehicle frame assemblies, such as sport utility vehicles (suv) and automobile cradles, as well.

In the drawings, where like numerals indicate like elements, there is shown a vehicle frame assembly in accordance with the present invention. The drawings are schematic in that non-essential structures and elements have been omitted.

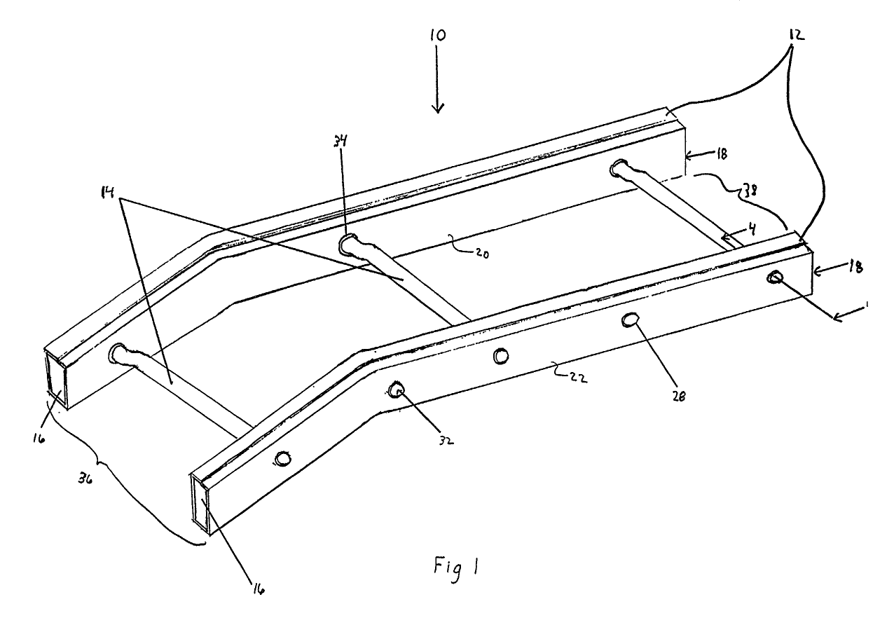

As shown in FIG. 1, a vehicle frame assembly or cradle 10 incorporating the features of this invention. The vehicle frame assembly 10 includes side rails 12 connected to one another by cross members 14, via tube-through-tube joints, forming a ladder-like orientation defining the vehicle frame. The cross members 14 are rigidly attached to the side rails, as will be described in further detail herein below.

Each side rail 12 is an elongated member having a first or front end 16, a second or rear end 18, an inner wall 20, and an outer wall 22. The side rails 12 are made of a material of sufficient stiffness to form a rigid vehicle frame, e.g. steel, aluminum, an extruded material, or the like. The side rail 12 may be a unitary member or comprise a plurality of portions rigidly attached to one another. The side rails 12 may have any cross sectional shape necessary to meet the needs of the frame. Further, side rails 12 may be curved along its longitudinal axis as required.

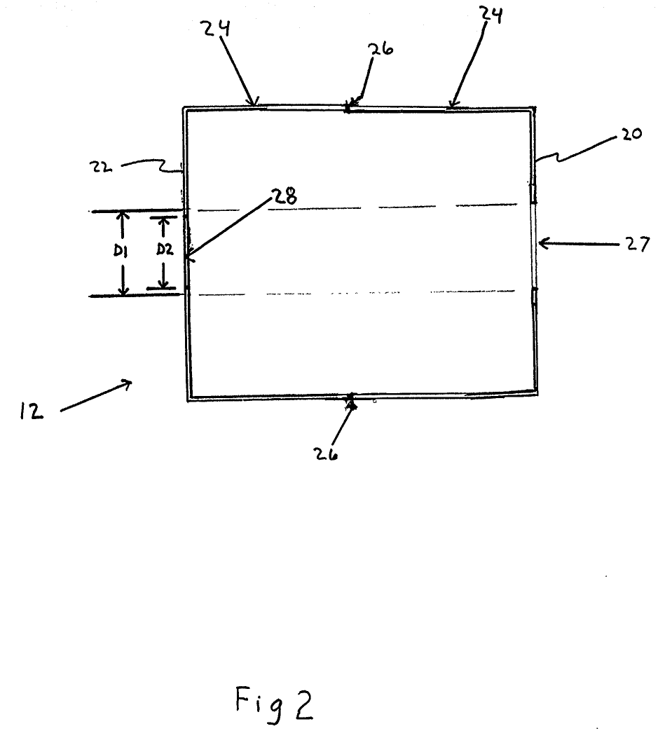

As shown in FIG. 2, portions of the side rail 12 are formed as an elongated rectangular tube formed of two c-shaped members 24 rigidly attached by welds 26. This is often incorporated where additional strength or rigidity is required, for example, where cross members 14 are attached. Alternatively, the side rails may be non-tubular such as a “single-wall” member.

In order to accomplish the efficient attachment of cross member 14 to the side rail 12, at least one coaxially aligned hole extends through both inner wall 20 and outer wall 22 of side rail 12. Specifically, aperture 27 is formed in inner wall 20 and is coaxial to aperture 28 formed in outer wall 22. Aperture 27 has a diameter D1 that is greater than diameter D2 of aperture 28. Aperture 27, having a larger diameter, increases the margin of error in the process of inserting a cross member 14 as will be explained in greater detail herein below. Alternatively, the diameter of the coaxial apertures may be the same size, or any size desired.

Cross member 14 is an elongated hollow member having opposed ends 32. Cross member 14 is made of a material of sufficient stiffness, such as steel, aluminum, or an extruded material, to form a rigid frame member. Cross member 14 is preferably an elongated tube with a circular cross section. However, the elongated cross member 14 may extend in a non-linear fashion to provide clearance for other components, such as the gas tank, engine, or the like.

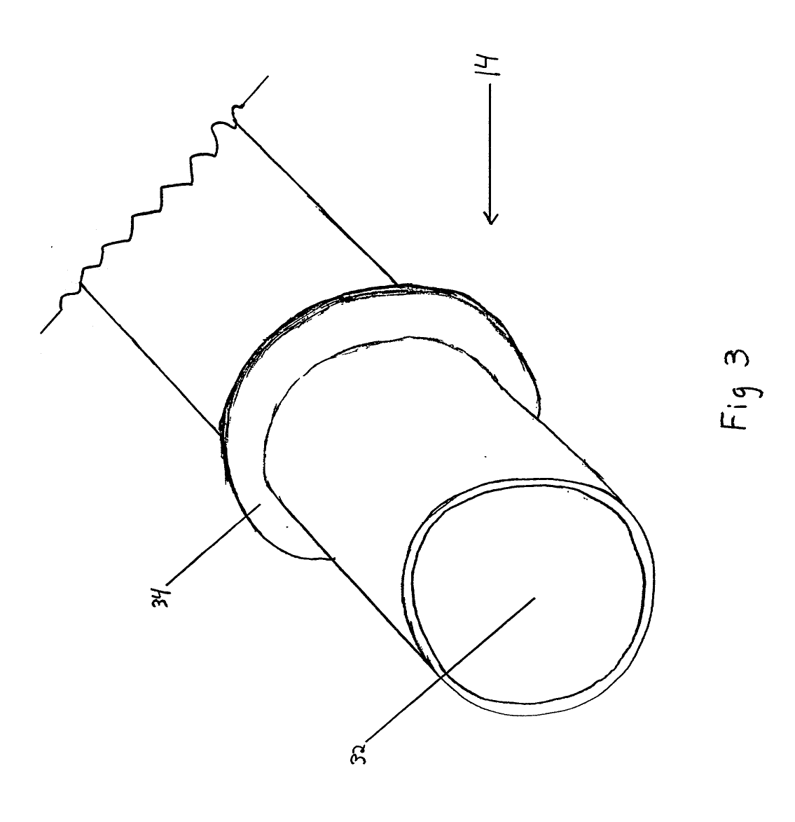

As shown in FIG. 3, a collar or stop member 34 is formed on the cross member proximate the ends 32. The collar 34 extends radially outwardly from the outer surface of cross member 14, providing a diameter greater than the rest of the cross member 14. A collar 34 may be located proximate one end of cross member 14 or at both ends. The collar or stop member 34 makes the coaxial alignment of apertures 27 and 28 less critical as the collar 34 is shaped so as to cover or make up for any difference in the alignment of the axial holes or difference in diameter. Further, collar 34 allows for the use of a larger diameter D1 for inner aperture 27.

Collar 34 is formed to be integral with cross member 14 by a standard end forming process that uses a clamping tool to hold the cross member while a hydraulic ram cylinder advances with a form tool to form the collar 34. However, collar 34 may be formed by other methods such as an extrusion process, bending, or the like.

Alternatively, a cross member 14 may have a stepped diameter or a conical section (not shown), wherein the outermost portion of each end of cross member 14 has a diameter less than the rest of the cross member 14. The collar or stop member 34 is formed by the increased diameter portion of cross member 14.

Referring to FIG. 1, two side rails 12 are positioned to form a left side longitudinal member and a right side longitudinal member, i.e., the left and right sides of the vehicle frame respectively. A plurality of cross members 14 are inserted into a corresponding number of coaxial holes in the side rails 12, and rigidly attached thereto, as shown. The side rails 12 and plurality of cross members 14 define a ladder-like frame having a forward portion 36 and a rearward portion 38 that correspond to the front and rear of the vehicle.

Method of Assembly of Vehicle Frame

The present invention also contemplates a method of assembling a vehicle frame using tube-through-tube joints. The method includes providing the various components of a vehicle frame 10 as shown in FIGS. 1 through 3. Side rails 12 are provided with the number of axially aligned holes required for the intended vehicle. Cross members 14 are provided in number corresponding to the number of axial holes in the side rails 12.

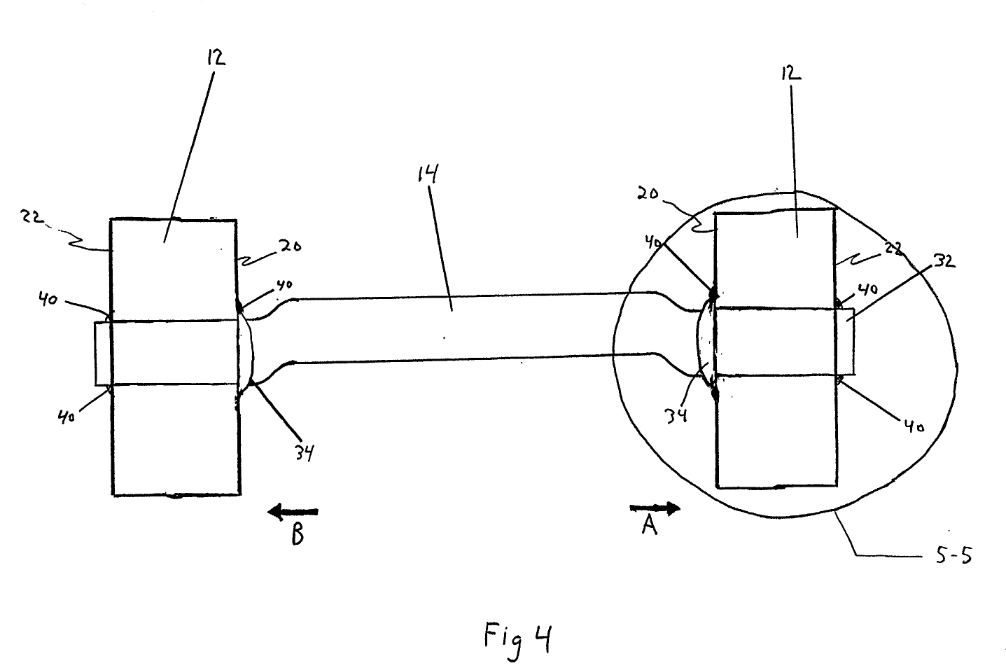

As shown in FIG. 4, one end of cross member 14 is inserted, as indicated by arrow A, into aperture 27 of inner wall 20 and extended completely through the side rails 12, through aperture 28 and beyond outer wall 22 until collar 34 complimentarily engages inner wall 20. The opposite end of cross member 14 is inserted into a corresponding aperture 27 in the other side rail 12, as indicated by arrow B. This procedure is repeated for all the cross members 14.

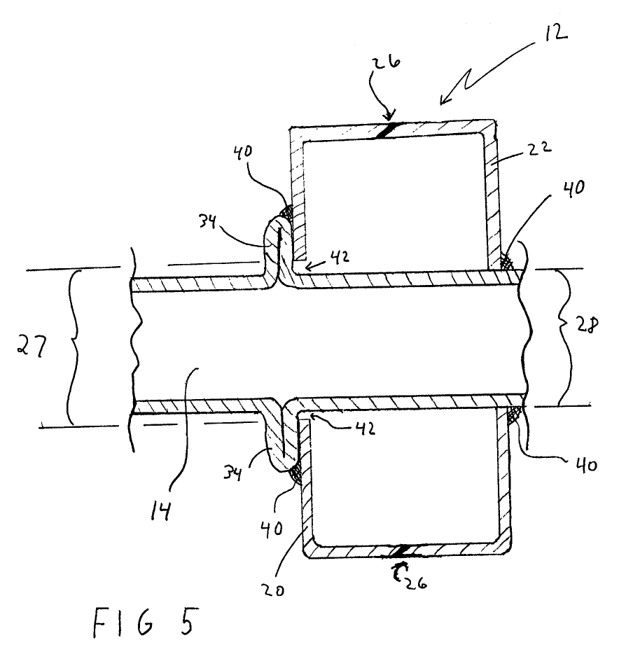

As stated above, aperture 27 has a greater diameter than aperture 28. Having an inner aperture larger than the outer aperture greatly reduces assembly time and the occurrence of misaligned cross members requiring discarding of the vehicle frame. With the current invention, assembly tools only have to align cross member 14 with aperture 28 in the outer wall of side rail 12 rather than apertures in both the inner wall 20 and outer wall 22 of the side rails. As shown in FIG. 5, the difference in the two aperture diameters makes the coaxial alignment of apertures 27 and 28 less critical, as the collar 34 is shaped so as to cover or make up for any gaps 42 created by aperture 27 being larger than the outer diameter of cross member 14.

The plurality of cross members 14 are rigidly attached to side rails 12 by welds 40 at the joint of cross member 14 and outer wall 22, or the joint of cross member 14 and the circumference of collar 34, or both locations. Alternatively, a press fitting bushing, friction fit, or the like may be incorporated to connect cross member 14 to side rails 12.

Extension of the cross members 14 through side rails 12 provides two rigid attachment points of the cross member 14 to the side rail 12 at the inner and outer walls of side rails 12, creating a much more rigid joint. More rigid joints create a stiffer vehicle frame, which improves vehicle performance, such as steering, handling, and the like.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1) A support structure for use in a vehicle comprising:
a left and a right side rail, each side rail comprising:
a first and second end; and
a wall with an aperture;
a cross member extending between the left side rail and the right side rail, the cross member having:
an inner and outer surface;
a first and a second end; and
at least one collar extending radially outwardly from the outer surface proximate an end of the cross member; and
the cross member extending through the aperture in the left and right side rails, the cross member rigidly attached to the side rails, and the at least one collar engaging a portion of one of the side rails.

2) The support structure of claim 1, wherein the support structure is a vehicle frame.

3) The support structure of claim 1, wherein the support structure is an automotive cradle.

4) The support structure of claim 2, wherein the left and right side rails comprise an inner wall portion and an outer wall portion, the inner and outer wall portions having coaxially aligned apertures.

5) The support structure of claim 4, wherein the cross member extending between said left and right side rails extends outwardly beyond the outer wall.

6) The support structure of claim 5, comprising a plurality of cross members.

7) The support structure of claim 6, wherein each side rail comprises a plurality of axially aligned apertures.

8) The support structure of claim 7, wherein said cross members are tubular formed members.

9) The support structure of claim 1, wherein the collar is welded to the side rails.

10) The support structure of claim 3, wherein the left and right side rails comprise an inner wall portion and an outer wall portion, the inner and outer wall portions having coaxially aligned apertures.

11) The support structure of claim 10, wherein the cross member extending between said left and right side rails extends outwardly beyond the outer wall.

12) The support structure of claim 11, comprising a plurality of cross members.

13) The support structure of claim 12, wherein each side rail comprises a plurality of axially aligned apertures.

14) The support structure of claim 13, wherein said cross members are tubular formed members.

15) The support structure of claim 2, wherein the vehicle frame is a truck or sport utility vehicle frame.

16) A method of manufacturing a vehicle frame assembly comprising
providing a pair longitudinally extending side rails positioned in parallel, the side rails having an inner wall, an outer wall, and a first and a second end;
providing a tubular cross member having inner and an outer surface, and a first and a second end;
deforming the cross member to have at least one collar extending radially outwardly from the outer surface proximate and end of the cross member;
securing the cross member transversely to the longitudinal side rails.

17) The method of claim 16, wherein the securing comprises forming a tube through tube joint.

18) The method of claim 16, wherein the securing comprises extending the cross member through a transversely extending aperture in each longitudinal side rail until the collar contacts the inner wall of the side rail, the first and second ends of the cross member extending outwardly beyond the outer wall of the side rails.

19) The method of claim 18, further comprising welding the cross member to the side rails.

20) The method of claim 16, further comprising providing a collar proximate each end of the cross member.

21) The method of claim 16, further comprising securing a plurality of cross members to the pair of side rails.

22) An automobile cradle assembly including:
at least two elongated side rails;
at least one tubular unitary cross member, the cross member having a stop member formed proximate each end of thereof, the stop member extending radially outwardly from outer surface of the tubular cross member; and
the cross member rigidly attached to the side rails via a tube through tube joint.

23) The automobile cradle assembly of claim 22 wherein the side rails are tubular with at least one axially aligned pair of apertures in the side wall defining a conduit engaging the outer surface of an end of the tubular cross member.

24) The automobile cradle assembly of claim 22 wherein side rails include a rectangular tube portion having an inner and outer wall, each wall having one of the pair of axially aligned apertures.

25) The automobile cradle assembly of claim 22 wherein the aperture on the inner wall is larger than the axially aligned aperture in the outer wall.

26) The automobile cradle assembly of claim 22 wherein the portion of the cross member between the stop members is non-linear.

27) A vehicle frame assembly including:
at least two elongated side rails;
at least one tubular unitary cross member, the cross member having a stop member formed proximate each end of thereof, the stop member extending radially outwardly from an outer surface of the tubular cross member; and
the cross member rigidly attached to the side rails via a tube through tube joint.

28) The vehicle frame assembly of claim 27, wherein the frame is a truck or sport utility vehicle frame.

29) The vehicle frame assembly of claim 28 wherein the side rails are tubular with at least one axially aligned pair of apertures in the side wall defining a conduit engaging the outer surface of an end of the tubular cross member.

30) The vehicle frame assembly of claim 28 wherein side rails include a rectangular tube portion having an inner and outer wall, each wall having one of the pair of axially aligned apertures.

31) The vehicle frame assembly of claim 28 wherein the aperture on the inner wall is larger than the axially aligned aperture in the outer wall.

32) The vehicle frame assembly of claim 28 wherein the portion of the cross member between the stop members is non-linear.
